(19) United States
(12) Patent Application Publication
(10) Pub. No.: US 2011/0000073 A1
(43) Pub. Date: Jan. 6, 2011

(54) Leaflet Alignment Fixture and Methods Therefor

(75) Inventors: Patrick O'Fallon, Santa Cruz, CA (US); Van Huynh, Garden Grove, CA (US); Jun Yang, Dove Canyon, CA (US)

Correspondence Address: JACKSON & CO., LLP, 6114 LA SALLE AVENUE, #507, OAKLAND, CA, 94611-2802, US

(73) Assignee: Medical Entrepreneurs II, Inc., Scotts Valley, CA (US)

(21) Appl. No.: 12/752,084

(22) Filed: Mar. 31, 2010

Related U.S. Application Data
(60) Provisional application No. 61/165,490, filed on Mar. 31, 2009.

(51) Int. Cl. B25B 27/14; B23P 11/00

(52) U.S. Cl. 29/464; 29/281.1; 29/559; 29/281.5

(57) ABSTRACT

Described herein is an assembly and alignment tool for aligning leaflets of a soft leaflet prosthetic heart valve and fix the leaflets to each other and/or to a wireform or stent. In embodiments, the assembly or alignment tool includes a mandrel configured to support one or more leaflets of a prosthetic valve. The mandrel includes at least one suture hole disposed on the surface thereof to allow a needle to pass through when sewing the one or more leaflets to a wireform.

### RELATED APPLICATION

The present application claims priority under 35 U.S.C. §119(e) to U.S. Provisional Patent Application No. 61/165,490 filed on Mar. 31, 2009, entitled “Leaflet Alignment Fixture and Methods Therefor”, the disclosure of which is incorporated herein by reference in its entirety for all purposes.

### TECHNICAL FIELD

The present disclosure is directed to tools configured to align and fix leaflets of a prosthetic heart valve and methods of making and employing such tools.

### BACKGROUND

The human heart has four major valves which control the direction of blood flow in the circulation. The aortic and mitral valves are part of the “left” heart and control the flow of oxygen-rich blood from the lungs to the body, while the pulmonic and tricuspid valves are part of the “right” heart and control the flow of oxygen-depleted blood from the body to the lungs. The aortic and pulmonic valves lie between a pumping chamber (ventricle) and major artery, preventing blood from leaking back into the ventricle after it has been ejected into the circulation. The mitral and tricuspid valves lie between a receiving chamber (atrium) and a ventricle preventing blood from leaking back into the atrium during ejection.

Heart valves may exhibit abnormal anatomy and function as a result of congenital or acquired valve disease. Congenital valve abnormalities may be well-tolerated for many years only to develop into a life-threatening problem in an elderly patient, or may be so severe that emergency surgery is required within the first few hours of life. High blood pressure may also lead to cardiac valve abnormalities. Acquired valve diseases include degenerative processes (e.g., Barlow's Disease, fibroelastic deficiency), inflammatory processes (e.g., Rheumatic Heart Disease) and infectious processes (e.g., endocarditis). In addition, damage to the ventricle from prior heart attacks (i.e., myocardial infarction secondary to coronary artery disease) or other heart diseases (e.g., cardiomyopathy) can distort the valve's geometry causing it to dysfunction.

Since heart valves are passive structures that simply open and close in response to differential pressures on either side of the particular valve, the problems that can develop with valves can be classified into two categories: (1) stenosis, in which a valve does not open properly, and (2) insufficiency (also called regurgitation), in which a valve does not close properly. Valve stenosis is present when the valve does not open completely causing a relative obstruction to blood flow. Valve regurgitation is present when the valve does not close completely causing blood to leak back into the prior chamber. Stenosis and insufficiency may occur concomitantly in the same valve or in different valves. Both of these conditions increase the workload on the heart and are very serious conditions. The severity of this increased stress on the heart and the patient, and the heart's ability to adapt to it, determine whether the abnormal valve will have to be surgically replaced or, in some cases, repaired. If left untreated, these conditions can lead to debilitating symptoms including congestive heart failure, permanent heart damage and ultimately death.

Dysfunctional valves can either be repaired, with preservation of the patient's own valve, or replaced with some type of mechanical or biologic valve substitute. Since all valve prostheses have some disadvantages (e.g., need for lifelong treatment with blood thinners, risk of clot formation and limited durability), valve repair, when possible, is usually preferable to replacement of the valve. Many dysfunctional valves, however, are diseased beyond the point of repair.

Dysfunction of the left-sided valves—the aortic and mitral valves—is typically more serious since the left ventricle is the primary pumping chamber of the heart. The aortic valve is more prone to stenosis, which typically results from buildup of calcified material on the valve leaflets and usually requires aortic valve replacement. Regurgitant aortic valves can sometimes be repaired but are usually replaced. In modern societies, the most common mitral valve pathologies involve regurgitation due to gross billowing of leaflets to relatively minor chordal lengthening as well as ischemic disease. In the majority of these cases, the mitral valve leaflets are soft and pliable, and can be retained over the long-term in various repair procedures. However, in third world countries and in centers with high rates of immigration from third world countries, the most common pathology or condition is rheumatic mitral valve disease. This produced thickened, impliable leaflets with grossly deformed chords, or chordae tendinae, often combined with fusion of the two leaflets. Rheumatic valve are not suitable for any type of repair procedure and, accordingly, are almost always replaced.

Because the demands on the right side of the heart are significantly less than on the left, dysfunctions involving the pulmonic and tricuspid valves are far less common. The pulmonic valve has a structure and function similar to that of the aortic valve. Dysfunction of the pulmonic valve is nearly always associated with complex congenital heart defects. Pulmonic valve replacement is occasionally performed in adults with longstanding congenital heart disease. The anatomy and function of the tricuspid valve are similar to that of the mitral valve. It also has an annulus, chords and papillary muscles but has three leaflets (anterior, posterior and septal). The shape of the annulus is slightly different, more snail-shaped and slightly asymmetric.

Prosthetic heart valves can be used to replace any of the heart's valves. Two primary types of heart valve prostheses are known. One is a mechanical-type heart valve which uses a pivoting mechanical closure or a ball and cage design to provide unidirectional blood flow. The other is a “bioprosthetic” valve which is constructed with leaflets made of natural tissue and which function much like the leaflets of the natural human heart valve in that they imitate the natural action of the heart valve leaflets, e.g., they seal against each other or coapt between adjacent tissue junctions known as commissures. Another type of prosthetic valve has a structure similar to that of the bioprosthetic valves but whose leaflets are made from flexible synthetic material.

Each type of prosthetic valve has its own advantages and drawbacks. Presently, mechanical valves have the longest durability of available replacement heart valves. However, implantation of a mechanical valve requires a recipient to be prescribed anticoagulants to prevent formation of blood clots. Continuous use of anticoagulants can be dangerous, as it greatly increases the user's risk of serious hemorrhage. In addition, a mechanical valve can often be audible to the recipient and may fail without warning, which can result in serious consequences, even death.

In contrast, prosthetic valves having bioprosthetic and/or synthetic leaflets are flexible and silent, and those employing natural tissue leaflets do not require the use of blood thinners. However, naturally occurring processes within the human body may stiffen or calcify the leaflets over time, particularly at high-stress areas of the valve such as at the commissure junctions between the valve leaflets and at the peripheral leaflet attachment points or “cusps” at the outer edge of each leaflet. Further, the valves are subject to stresses from constant mechanical operation within the body. In particular, the leaflets are in tension when in a closed position and are in compression when in an open position. Accordingly, these types of prosthetic valves wear out over time and need to be replaced. Bioprosthetic and synthetic leaflet heart valves are also considerably more difficult and time consuming to manufacture than mechanical heart valves as they are made substantially by hand by highly trained and skilled personnel.

Bioprosthetic valves include homograft valves which include wholly harvested valves from human donors or cadavers; allograft valves which include biomaterial supplied from human cadavers; autologous valves which include biomaterial supplied from the individual receiving the valve; and xenograft valves which include biomaterial obtained from non-human biological sources including pigs, cows or other animals.

Currently available xenograft valves are constructed either by sewing the leaflets of an intact aortic valve from a pig to a wire frame/form or stent (to hold the leaflets in proper position), or by constructing valve leaflets from the pericardial sac (which surrounds the heart) of cows, horses, pigs or other animals, and sewing them to a wire frame/form which in turn is coupled to a support stent or ring, often referred to as a pericardial valve. An example of a commercial valve having the latter configuration is the Carpentier-Edwards Perimount™ Pericardial Valve. That valve's stent has an upper surface “matching” the lower surface of the wireform between which the edges of the leaflets are sandwiched. In either of these types of xenograft valve embodiments, the wire frame/stent is constructed to provide a dimensionally stable support structure for the valve leaflets which imparts a certain degree of controlled flexibility to reduce stress on the leaflet tissue during valve opening and closure. The wire frames/stents are covered with a biocompatible cloth (usually a polyester material such as Dacron™ or PTFE.) which provides sewing attachment points for the leaflet commissures and cusps. Alternatively, a cloth covered suture ring can be attached to the wire frame or stent to provide an attachment site for sewing the valve structure in position within the patient's heart during a surgical valve replacement procedure.

Although a number of heart vales are available, creating of each heart valve can be a painstaking and time consuming process. For example, when sewing leaflets on a wireform, the wireform or leaflets may shift and become misaligned. Realigning the leaflets may cause stress on the leaflets and/or the wireform which may in turn cause the wireform to be defective or damaged. What is needed therefore is a manufacturing process that enables heart valve creation in a repeatable and less time consuming manner.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In aspects of the present disclosure, an alignment tool is provided to align leaflets of a soft leaflet prosthetic heart valve and fix the leaflets to each other and/or to a wireform or a stent. In one aspect, the curvature of the leaflets is replicated where the leaflets rest on the curvature surface. Once placed on the surface of the alignment tool, the leaflets may be temporarily stitched together. A wireform of a heart valve is placed on top of the leaflets and the wireform and the leaflets are sewn together while held in place by the fixture. In one aspect, a manufacturing process with the aforementioned alignment tool allows for less adjustment and stress on the wireform and leaflets during the heart valve assembly and construction process. Further, in another aspect, the alignment tool allows for a repeatable and less time consuming assembly.

### BRIEF DESCRIPTION OF THE DRAWINGS

FIG. 1 is a top view of a mandrel of a fixture tool in one embodiment of the present disclosure;

FIG. 2 is a perspective view of a mandrel of a fixture tool in one embodiment of the present disclosure;

FIG. 3 is a side view of a mandrel of a fixture tool in one embodiment of the present disclosure;

FIG. 4 is a perspective view of a mandrel and stabilization component of a fixture tool in one embodiment of the present disclosure;

FIG. 5 is a perspective view of a mandrel and stabilization component of a fixture tool in another embodiment;

FIG. 6 is a perspective view of a fixture tool with a wireform being placed thereon in one embodiment of the present disclosure; and

FIG. 7 is a perspective view of an alternative embodiment of a fixture tool.

### DETAILED DESCRIPTION

As described in further detail below, in accordance with the various embodiments of the present disclosure, provided are methods and tools for improved alignment and sewing of leaflets for prosthetic heart valves.

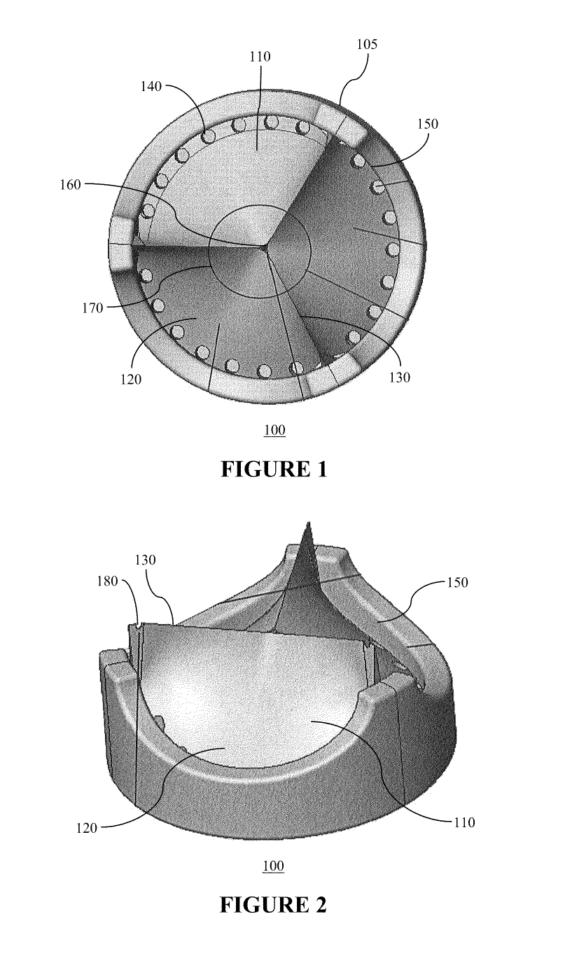

FIG. 1 is a top view of a mandrel 110 of a fixture tool 100 in one embodiment of the present disclosure. Use of the fixture tool 100 for alignment and/or support for the leaflets and/or wireform during the manufacturing process for a prosthetic heart valve such as described herein, allows for minimal stress and adjustment on the wireform or stent and leaflets during the sewing process. The reduced stress and required adjustment allows for less time consuming repeatable assembly and minimizes the likelihood of damage to the heart valve during manufacture. The fixture tool 100, or components described herein, may also be configured for use during the construction and/or assembly of devices, such as valves other than prosthetic heart valves, such as, for example, prosthetic venous valves.

In general, the fixture tool 100 may be manufactured of a variety of materials, such as rigid, non-brittle, biocompatible, and non-leaching materials, for example plastic or stainless steel. Although not shown, the fixture tool 100 may also include a handle that extends from a side or bottom portion of the fixture tool 100. The handle may also be disposed at various angles depending on preference of the user.

In embodiments, the fixture tool 100 may comprise an outer portion 105 having a plurality of cusps and plateaued extensions. In embodiments, the cusps of the outer portion 105 of the fixture tool 100 are configured to substantially align with a wireform while the plateaued extensions may be used for leaflet support.

The fixture tool 100 also includes a mandrel 110 configured in the shape of an inflow side of leaflets of a prosthetic heart valve including replicating a curvature of leaflets and support the entire leaflet surface. In other embodiments, the mandrel 110 has a partial segmented leaflet surface. As briefly discussed above, leaflets used in the construction of the valve may be made from animal tissue or human tissue. It is also contemplated that the leaflets may be made of non-animal material such as a flexible polymer.

The mandrel 110 may also be configured to replicate a curvature of leaflets, including closed, no stress, and open positions, regardless of the complexity of the curvature. Regardless of configuration, the mandrel 110 is configured to hold and/or support one or more leaflets of the prosthetic valve in a desired location, orientation, alignment, or combination thereof during construction and/or assembly of the valve including sewing one or more leaflets to a wireform or stent. Once the leaflets have been placed on the mandrel 110, the leaflets may be stitched together. A wireform of a prosthetic heart valve may then be placed on top of the leaflets and the wireform and the leaflets are sewn together being held in place by the fixture tool 100.

Because of the delicate nature of the leaflets, embodiments provide that the surface of the mandrel 110 may be coated with a laminate or substance to reduce the friction of the surface. Therefore, when the leaflet is placed on the surface, frictional damage to the leaflet is reduced. Still yet other embodiments provide that a wetting mechanism (not shown) may be provided with the fixture tool 100 that may be used to keep one or both surfaces of the leaflet moist during the sewing operation as any drying of the tissue may result in calcification which may weaken the leaflets. Such a wetting mechanism may consist of a compact misting system that periodically sprays a mist over the leaflets during sewing. Other embodiments provide that wetting substance may also be periodically placed on the surface of the mandrel 110 prior to and during sewing of the leaflets.

In embodiments, the mandrel 110 comprises at least three sections, with each section having a leaflet surface onto which leaflets are placed. In one aspect, the outer diameter of the leaflet surface may be between 0.500″ and 2.000″ although other dimensions may be used, for example, the outer diameter may be less than 0.500″, such as 0.300″ or 0.100″ or less, or may be greater than 2.000″ such as 2.500″ or 3.000″ or greater. As will be described in greater detail below, each of the three mandrel sections has a trough portion 120 and a peak portion 130. Mandrel 110 also includes a plurality of suture holes 140 or slits disposed on a surface next to a lip 150. In application, the mandrel 110 may be used to align one or more leaflets of a heart valve to one another, align a wireform to one or more leaflets, hold one or more leaflets in place in order for the leaflets to be sewn together, hold one or more leaflets and/or a wireform in place in order to sew the leaflets and wireform together, or a combination thereof.

As briefly discussed above, the mandrel 110 may include one or more suture holes 140 disposed on a surface of the mandrel 110. The suture holes 140 are configured to allow a needle to pass through the surface of the mandrel 110 when sewing leaflets together and/or sewing leaflets to a wireform. In embodiments, the suture holes 140 have a diameter in the range of from about 0.01″ to 0.25″. In other embodiments, the diameter of the suture holes 140 may be less than 0.01″, such as 0.05″ or less or greater than 0.25″, such as 0.30″ or 0.50″ or greater. Although a specific number of suture holes 140 are shown in FIG. 1, it is contemplated that any number of suture holes 140 may be disposed in the mandrel 110 to assist in sewing. For example, the size of a prosthetic heart valve may vary. Therefore, the size of the fixture tool 100, as well as the components of the fixture tool 100, including the mandrel 110, will also vary in size thus affecting the number of holes or slits.

The mandrel 110 may also include a lip 150 configured to keep the leaflets in the correct location and orientation when the leaflets are placed on the surface of the mandrel 110. Thus, as each leaflet is placed on the mandrel 110, the edge of each leaflet may rest against the lip 150 for support.

The mandrel 110 may also be configured to create a coaptation gap 160 between each of the leaflets. Depending on application, the coaptation gap may be in the range of from about 0.000″ to 0.200″. In yet other embodiments, the leaflets may be positioned such that there is no coaptation gap. In yet other embodiments, the coaptation gap may be greater than 0.200″, such as 0.2500″, 0.300″, 0.3500″, 0.400″, 0.500″ or greater. Regardless of the configuration of the coaptation gap 160, the lip 150 enables the leaflets to be aligned in such a manner as to keep the desired coaptation gap 160 constant.

As will be explained in greater detail below, the fixture tool 100 may also include a stabilization component, such as a cap, that rests on top of the leaflets when the leaflets are placed on the surface of the mandrel 110. In embodiments, the cap sits on the top portion of the mandrel 110 that is indicated by the guide circle 170. In embodiments, the cap may have various sizes depending on the size of the fixture tool. It is also contemplated that the cap may cover more area or less area than is shown by the guide circle 170.

FIG. 2 is a perspective view of a mandrel 110 of a fixture tool 100 in one embodiment of the present disclosure. As shown in FIG. 2, each section of the mandrel 110 has a concave leaflet surface, or trough portion 120. Each of the trough portions 120 of the mandrel 110 have an upward slope from the lip 150 to the peaks 130. In one aspect, the height from trough portions 120 to the peaks may be between 0.250″ and 1.000″. Although specific dimensions are mentioned, it is contemplated that they heights may vary, such as peaks smaller than 0.250″ or greater than 1.000″. Each of the trough portions 120 may also have a curvature configured in a number of different ways that corresponds to a desired curvature of the leaflets.

In embodiments, a plurality of wireform slits 180 are disposed on peak portions 130 of the mandrel 110. The wireform slits 180 may be used to locate a wireform, such as wireform 210 (FIG. 6), when the wireform has been placed on the mandrel 110. In one aspect, the position of the wireform slits 180 may be flush or more from the outside diameter of the wireform. Embodiments provide that the depth of the wireform slits 180 may be at least 0.005″ deep although it is contemplated that a variety of depths and widths of slits 180 may be used depending on the application.

In yet another embodiment, the fixture tool 100 may include a guide configured to keep the mandrel 110 and a stabilization component, such as will be described in detail below, in alignment. The guide may include, among others, opposing similar surface contours, a protruding guide structure in the form of a triangle, circle, oval, square, etc., notches, holes, needles, clamps, or a combination thereof. The guide may also help keep a constant coaptation gap between the leaflets.

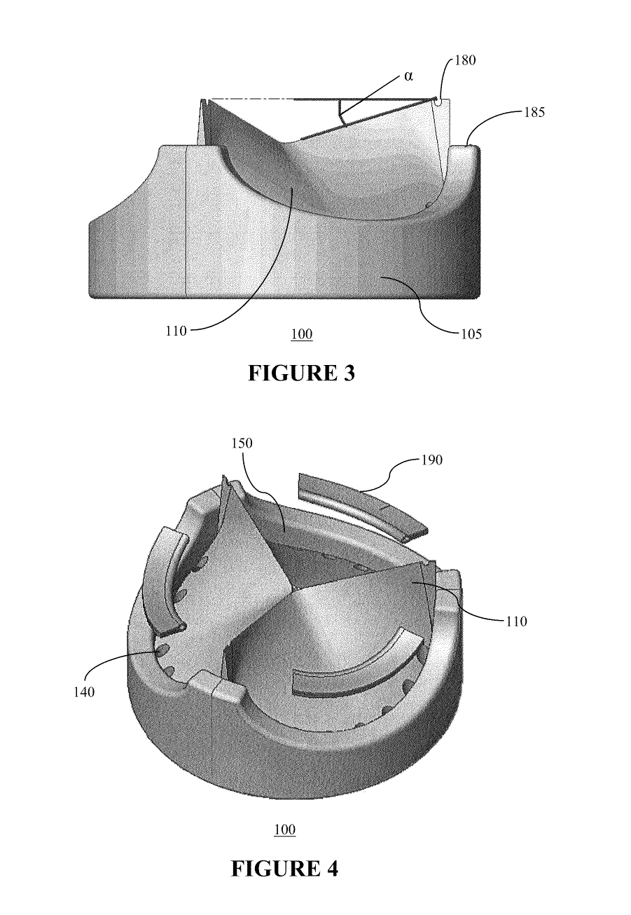

FIG. 3 is a side view of a mandrel 110 of a fixture tool 100 according to embodiments. As shown in FIG. 3, the fixture tool 100 may also include a tab shelf 185 disposed on the plateaued extensions of the outer portion 105 of the fixture tool 100. The tab shelf 185 is configured to allow room for one or more leaflet tabs to be placed thereon. When placed on the tab shelf 185, the leaflet tabs can be joined together without interference, thus allowing for easier sewing and/or assembly. In embodiments, the height from the tab shelf 185 to the peak portion 130 is approximately 0.100″. Other embodiments provide that the height from the tab shelf 185 to the peak portion 130 may be greater than or smaller than 0.100″.

When sewn or otherwise coupled together, the leaflets may be configured such that the leaflet edge of the outflow side of the leaflets is higher with respect to the valve base than the trough of the leaflets, or the point in which the leaflets meet at the coaptation gap 160 such as shown in FIG. 3. The difference in height of the outflow side of the leaflets, represented by the angle α, may be between about 5 and 25 degrees. In other embodiments, the angle α may be between about 0 and 30 degrees. Still yet other embodiments provide that the angle α may have other varying degrees dependent on the size, configuration or type of the valve.

FIG. 4 is a perspective view of a mandrel 110 and stabilization component 190 of a fixture tool 100 in one embodiment of the present disclosure. In one aspect, the stabilization component may be used to sandwich leaflets between the mandrel 110 and the stabilization component 190 such that the leaflets are better stabilized. Embodiments provide that the stabilization component 190 is configured such that when it is placed on top of one or more leaflets, the stabilization component fits within the lip 150 of the mandrel 110. To better secure the leaflets in place, the stabilization component 190 may have a plurality of needles protruding from the underside thereof. The needles may then be placed through the leaflet into corresponding suture holes 140. It is also contemplated that the stabilization component 190 may be made of a material in which needles may pass through the surface and into corresponding suture holes 140. Still yet other embodiments provide the stabilization component 190 may be slightly weighted or have a frictional surface to better stabilize the leaflets.

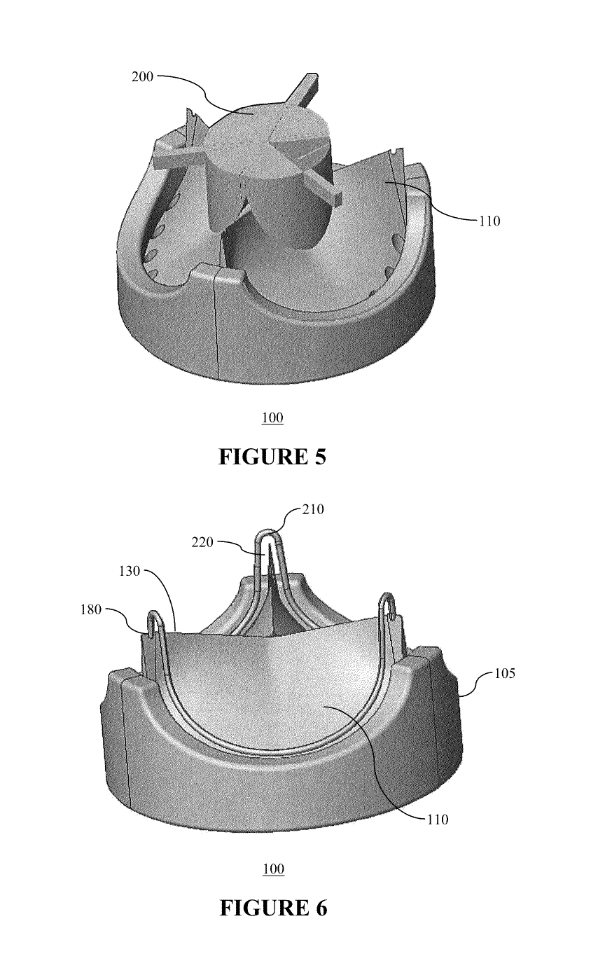

FIG. 5 is a perspective view of a mandrel 110 and stabilization cap 200 of a fixture tool 100 in another embodiment. The stabilization cap 200 may be configured to sandwich the leaflets between the stabilization cap 200 and the mandrel 110 after the leaflets have been placed thereon. As briefly described above, the stabilization cap 200 may sit on a portion of the top of the mandrel 110 indicated by the circle 170 (FIG. 1). It is also contemplated that the stabilization cap 200 may sit on more or less surface area than as defined by the circle 170. Additionally, the cap may have various sizes depending on the size of the fixture tool 100. In an embodiment, the stabilization cap 200, or portions thereof, may be made from a soft or sponge like material so that when the stabilization cap 200 is placed on the leaflet surface, the stabilization cap 200 does not damage the leaflets or the leaflet edges.

Embodiments provide that at least an underside of the stabilization cap 200 may be in the shape of the outflow side of the leaflets thus enabling the stabilization cap 200 to rest on the leaflets and secure them in place. The stabilization cap may also include a frictional surface to better keep the leaflets in the desired alignment.

Other embodiments provide that additional stabilization components, means and combinations may be used. For example, a stabilization component may be in the shape of a partial wireform or a component in the shape of a partial wireform, or a complete wireform or a component in the shape of a complete wireform. Additionally, a stabilization component may include structures having needles configured to fit within or through holes or slits in the mandrel 110 or structures that use friction or a vacuum between the leaflets and the mandrel surface. Still yet other embodiments provide that ball contacts on one or more leaflet surfaces or one or more clamps to clamp the leaflets together or in place may be used. As will be appreciated by one of ordinary skill in the art any combinations of the above may also be used.

FIG. 6 is a perspective view of a fixture tool 100 with a wireform 210 being placed thereon in one embodiment of the present disclosure. As shown in FIG. 6, the outer portion 105 of the fixture tool 100 has a shape that substantially conforms to that of the wireform 210. As explained above, a plurality of slits 180 are disposed in the peak portions 130 of the mandrel 110. In embodiments, the slits 180 are located on the peak portions 130 of the mandrel 110 such that when the wireform 210 is placed thereon, the slits 180 sit just to the outside of the wireform 210 such as shown in FIG. 6. The slits 180 may be used to locate and align the wireform 210.

Although the slits 180 are shown just to the outside of the wireform 210, it is contemplated that the slits 180 may be positioned in various locations along the peak portions 130 of the mandrel 110. For example, the slits 180 may be flush against the outer edge of the mandrel 110 or may be directly underneath the peak portions of the wireform 210. Alternatively, the slits 180 may be located on the peak portions 130 just to the inside of the peak portions of the wireform 210.

When the wireform 210 is placed on the fixture tool 100, a gap 220 is formed between an underside of the wireform 210 and the surface of the mandrel 110. In embodiments, the size of the gap 220 between the wireform 210 and the mandrel 110 is constant or substantially constant. The gap 220 is configured such that the leaflets may be sandwiched in between the wireform 210 and the mandrel 110. Once the wireform has been placed on the fixture tool 100, the leaflets may be secured to the wireform.

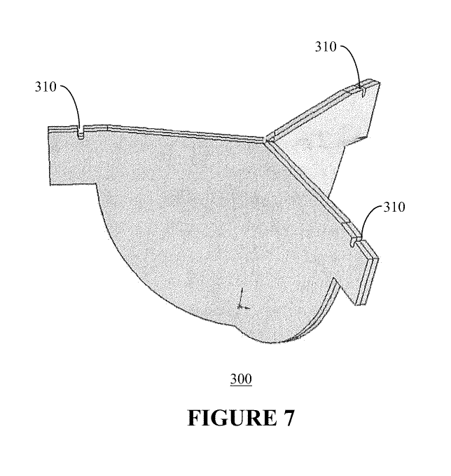

FIG. 7 is a perspective view of an alternative embodiment of a fixture tool 300. In embodiments, the fixture tool 300 may be configured to align three leaflets and a wireform, such as, for example, wireform 210 (FIG. 6) prior to the leaflets being sewn onto the wireform. Although three leaflets are mentioned, it is contemplated that the fixture tool 300 may be used to align fewer or more than three leaflets.

Embodiments provide that the fixture tool 300 may be used separately or in conjunction with the outer portion 105 of the fixture tool 100. In lieu of trough portions such as described above with reference to FIG. 1, the three leaflet areas have flat or substantially flat sides that run from a bottom portion of the fixture tool to a top surface of the fixture tool 300. The fixture tool 300 also includes a plurality of wireform slits 310 disposed on the top surface. As with the wireform slits discussed above, wireform slits 310 may be used to locate and align a wireform when the wireform is placed on the fixture tool 300 and the wireform and leaflets may be sewn together. Although not shown, it is also contemplated that stabilization components, such as stabilization cap 200 (FIG. 5) may be used in conjunction with fixture tool 300 prior to sewing the leaflets and the wireform.

Although specific features have been explained above, it is contemplated that fixture tools, such as described above, may have many different configurations. For example, each component described above may be a separate component. In other embodiments, the components of the fixture tools may be integrated into a single unit. For example, the guide may be integral with the stabilization component and/or the mandrel.

Additionally, the fixture tools may be used to construct heart valves in a number of different configurations. For example, a mandrel, such as mandrel 110, may have a surface replicating an inflow side of one or more leaflets of a prosthetic valve in an open position. A stabilization component may also be configured to stabilize the leaflets of the valve in an open position. A guide may then be used to align the mandrel, the leaflets, the stabilization component, and/or wireform for assembly of the prosthetic valve in an open position.

Methods associated with the subject fixture tool are also contemplated within the scope of the present disclosure. The subject methods may include fabrication and/or assembly steps or activities, including but not limited to providing one or more leaflets, providing a mandrel configured to support the one or more leaflets, providing a stabilization component configured to stabilize the one or more leaflets on the mandrel, providing a guide configured to align the stabilization component and the mandrel in a desired alignment with the one or more leaflets, and sewing the one or more leaflets to a wireform.

The fixture tool of the present disclosure may be used with a variety of prosthetic heart valves, including those described in U.S. Pat. Nos. 4,106,129, 4,501,030, 4,647,283, 4,648,881, 4,885,005, 5,002,566, 5,928,281, 6,102,944, 6,214,054, 6,547,827, 6,585,766, 6,936,067, 6,945,997, 7,097,659 and 7,189,259 and U.S. Published Patent Application Nos. 2003/0226208 and 2006/0009842 and in U.S. patent application Ser. Nos. 11/754,249 published as US Publication No. 2008/0294248 and 11/754,250 published as US Publication No. 2008/0294247, the disclosures of each of which are incorporated herein by reference for all purposes.

In one aspect, an assembly tool for a prosthetic valve includes a mandrel configured to support one or more leaflets of a prosthetic valve, wherein the mandrel includes at least one suture hole disposed on the surface thereof, and wherein the at least one suture hole is configured to allow a needle to pass through when sewing the one or more leaflets to a wireform.

In one embodiment, the mandrel is configured in the shape of the inflow side of the one or more leaflets.

A further embodiment includes a stabilization component configured to stabilize the one or more leaflets on the mandrel.

Another further embodiment includes a guide configured to align the stabilization component and the mandrel in a predetermined alignment with the one or more leaflets.

The guide comprises opposing similar surface contours to at least one of the mandrel and the stabilization component in one embodiment.

In another embodiment, the guide includes a protruding structure.

In yet another embodiment, the protruding structure is in the form of a triangle, circle, oval, square, or a combination thereof.

In one embodiment, the stabilization component comprises a cap configured to rest on top of the one or more leaflets.

The cap is in the shape of the outflow side of the one or more leaflets in another embodiment.

In another embodiment, the stabilization component comprises at least one of a partial wireform shape or a complete wireform shape.

In yet another embodiment, the stabilization component comprises one or more needles.

In yet another embodiment, the stabilization component comprises a structure with at least one needle configured for placement in the at least one suture hole of the mandrel.

In another embodiment, the stabilization component comprises a component for providing a friction or vacuum between the one or more leaflets and the mandrel.

In yet another embodiment, the stabilization component comprises a clamp.

The suture holes are between about 0.01″ and 0.25″ in diameter in certain embodiments.

In one embodiment, the mandrel includes one or more slits to locate and align the wireform, wherein the wireform is configured to be placed on top of the one or more leaflets.

In another embodiment, the mandrel includes a lip configured to keep the one or more leaflets in a predetermined alignment.

The lip is configured to keep the one or more leaflets aligned in such a manner as to keep a constant coaptation gap in certain embodiments.

Other embodiments include a tab shelf configured to allow the one or more leaflets to join together without interference.

In one or more embodiments, one or more components of the tool are comprised of a rigid, non-brittle, biocompatible, and non-leaching material.

In certain embodiments, the material is plastic.

In other embodiments, the material is stainless steel.

The one or more leaflets of the prosthetic valve are comprised of a biological tissue in certain embodiments.

In one embodiment, the biological tissue is human pericardial tissue, animal pericardial tissue, dura mater, or a combination thereof.

In another embodiment, the one or more leaflets of the prosthetic valve are comprised of a synthetic material.

In one aspect, a method for assembling a prosthetic valve includes providing one or more leaflets; providing a mandrel configured to support the one or more leaflets; providing a stabilization component configured to stabilize the one or more leaflets on the mandrel; providing a guide configured to align the stabilization component and the mandrel in a desired alignment with the one or more leaflets; and sewing the one or more leaflets to a wireform; wherein the mandrel, stabilization component, and guide are configured to align the leaflets and the wireform in a desired configuration.

In one embodiment, the desired configuration includes the leaflets being aligned in such a manner as to include a coaptation gap.

In one embodiment, the coaptation gap is between 0.000 inches and 0.200 inches.

In another embodiment, the desired configuration includes the leaflets being aligned in such a manner as to include no coaptation gap.

In another aspect, an assembly tool includes an outer portion having a plurality of cusps and plateaued extensions; and a mandrel at least partially contained within the outer portion, wherein the mandrel has a surface configured to replicate an inflow surface of at least one leaflet of a prosthetic valve, and wherein the mandrel is configured to support the at least one leaflet in a predetermined alignment when the at least one leaflet is placed thereon.

One embodiment includes a plurality of suture holes disposed in a surface of the mandrel.

A further embodiment includes a stabilization component, wherein the stabilization component is configured to hold the at least one leaflet in the predetermined alignment when the at least one leaflet is placed on the mandrel.

In another embodiment, the mandrel has a plurality of wireform slits disposed on a surface, wherein the wireform slits are configured to locate and align a wireform when the wireform is placed thereon.

In yet another embodiment, the surface of the mandrel is configured to replicate an inflow surface of at least one leaflet of the prosthetic valve in an open position.

Another further embodiment includes a stabilization component, wherein the stabilization component is configured to stabilize the at least one leaflet of the prosthetic valve in the open position.

Yet another further embodiment includes a lip positioned between the mandrel and the outer portion, wherein the lip is configured to keep the leaflets aligned in such a manner as to keep a constant coaptation gap.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

It must be noted that as used herein and in the appended claims, the singular forms “a”, “an”, and “the” include plural referents unless the context clearly dictates otherwise. Thus, for example, reference to “a string” may include a plurality of such strings and reference to “the tubular member” includes reference to one or more tubular members and equivalents thereof known to those skilled in the art, and so forth.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

What is claimed is:

1. An assembly tool for a prosthetic valve, comprising:
a mandrel configured to support one or more leaflets of a prosthetic valve, wherein the mandrel includes at least one suture hole disposed on the surface thereof, and wherein the at least one suture hole is configured to allow a needle to pass through when sewing the one or more leaflets to a wireform.

2. The assembly tool of claim 1, wherein the mandrel is configured in the shape of the inflow side of the one or more leaflets.

3. The assembly tool of claim 1, further comprising a stabilization component configured to stabilize the one or more leaflets on the mandrel.

4. The assembly tool of claim 3, further comprising a guide configured to align the stabilization component and the mandrel in a predetermined alignment with the one or more leaflets.

5. The assembly tool of claim 4, wherein the guide comprises opposing similar surface contours to at least one of the mandrel and the stabilization component.

6. The assembly tool of claim 4, wherein the guide includes a protruding structure.

7. The assembly tool of claim 6, wherein the protruding structure is in the form of a triangle, circle, oval, square, or a combination thereof.

8. The assembly tool of claim 3, wherein the stabilization component comprises a cap configured to rest on top of the one or more leaflets.

9. The assembly tool of claim 8, wherein the cap is in the shape of the outflow side of the one or more leaflets.

10. The assembly tool of claim 3, wherein the stabilization component comprises at least one of a partial wireform shape or a complete wireform shape.

11. The assembly tool of claim 3, wherein the stabilization component comprises one or more needles.

12. The assembly tool of claim 3, wherein the stabilization component comprises a structure with at least one needle configured for placement in the at least one suture hole of the mandrel.

13. The assembly tool of claim 3, wherein the stabilization component comprises a component for providing a friction or vacuum between the one or more leaflets and the mandrel.

14. The assembly tool of claim 3, wherein the stabilization component comprises a clamp.

15. The assembly tool of claim 1, wherein the suture holes are between about 0.01″ and 0.25″ in diameter.

16. The assembly tool of claim 1, wherein the mandrel includes one or more slits to locate and align the wireform, wherein the wireform is configured to be placed on top of the one or more leaflets.

17. The assembly tool of claim 1, wherein the mandrel includes a lip configured to keep the one or more leaflets in a predetermined alignment.

18. The assembly tool of claim 17, wherein the lip is configured to keep the one or more leaflets aligned in such a manner as to keep a constant coaptation gap.

19. The assembly tool of claim 1, further comprising a tab shelf configured to allow the one or more leaflets to join together without interference.

20. The assembly tool of claim 1, wherein one or more components of the tool are comprised of a rigid, non-brittle, biocompatible, and non-leaching material.

21. The assembly tool of claim 20, wherein the material is plastic.

22. The assembly tool of claim 20, wherein the material is stainless steel.

23. The assembly tool of claim 1, wherein the one or more leaflets of the prosthetic valve are comprised of a biological tissue.

24. The assembly tool of claim 23, wherein the biological tissue is human pericardial tissue, animal pericardial tissue, dura mater, or a combination thereof.

25. The assembly tool of claim 1, wherein the one or more leaflets of the prosthetic valve are comprised of a synthetic material.

26. A method for assembling a prosthetic valve, the method comprising:
providing one or more leaflets;
providing a mandrel configured to support the one or more leaflets;
providing a stabilization component configured to stabilize the one or more leaflets on the mandrel;
providing a guide configured to align the stabilization component and the mandrel in a desired alignment with the one or more leaflets; and
sewing the one or more leaflets to a wireform;
wherein the mandrel, stabilization component, and guide are configured to align the leaflets and the wireform in a desired configuration.

27. The method of claim 26, wherein the desired configuration includes the leaflets being aligned in such a manner as to include a coaptation gap.

28. The method of claim 27, wherein the coaptation gap is between 0.000 inches and 0.200 inches.

29. The method of claim 26, wherein the desired configuration includes the leaflets being aligned in such a manner as to include no coaptation gap.

30. An assembly tool comprising:
an outer portion having a plurality of cusps and plateaued extensions; and
a mandrel at least partially contained within the outer portion, wherein the mandrel has a surface configured to replicate an inflow surface of at least one leaflet of a prosthetic valve, and wherein the mandrel is configured to support the at least one leaflet in a predetermined alignment when the at least one leaflet is placed thereon.

31. The assembly tool of claim 30, further comprising a plurality of suture holes disposed in a surface of the mandrel.

32. The assembly tool of claim 30, further comprising a stabilization component, wherein the stabilization component is configured to hold the at least one leaflet in the predetermined alignment when the at least one leaflet is placed on the mandrel.

33. The assembly tool of claim 30, wherein the mandrel has a plurality of wireform slits disposed on a surface, wherein the wireform slits are configured to locate and align a wireform when the wireform is placed thereon.

34. The assembly tool of claim 30, wherein the surface of the mandrel is configured to replicate an inflow surface of at least one leaflet of the prosthetic valve in an open position.

35. The assembly tool of claim 34, further comprising a stabilization component, wherein the stabilization component is configured to stabilize the at least one leaflet of the prosthetic valve in the open position.

36. The assembly tool of claim 30, further comprising a lip positioned between the mandrel and the outer portion, wherein the lip is configured to keep the leaflets aligned in such a manner as to keep a constant coaptation gap.
